(19) United States
(12) Patent Application Publication
(10) Pub. No.: US 2009/0086048 A1
(43) Pub. Date: Apr. 2, 2009

(54) SYSTEM AND METHOD FOR TRACKING MULTIPLE FACE IMAGES FOR GENERATING CORRESPONDING MOVING ALTERED IMAGES

(75) Inventors: Tao Jiang, Sherman Oaks, CA (US); Raphael Ko, Sherman Oaks, CA (US); Linh Tang, Sherman Oaks, CA (US)

Correspondence Address: FOUNTAIN LAW GROUP, INC., 18201 VON KARMAN AVENUE, SUITE 960, IRVINE, CA, 92612, US

(73) Assignee: Mobinex, Inc., Sherman Oaks, CA (US)

(21) Appl. No.: 12/233,528

(22) Filed: Sep. 18, 2008

Related U.S. Application Data
(60) Provisional application No. 60/976,377, filed on Sep. 28, 2007.

(51) Int. Cl. H04N 5/228; G06K 9/00

(52) U.S. Cl. 348/222.1; 382/118; 348/E05.031

(57) ABSTRACT

An image processing system and related method for simultaneously generating a plurality of partially- or fully-animated images on a display that substantially track the movements, changes in orientations, and changes in facial expressions of a corresponding plurality of face images captured by an image capturing device, such as a camera or video recorder. The image processing system includes graphic tools to allow a user to create the partially- or fully animated pictures on the display. Additionally, the image processing system has the capability of generating a video clip or file of the plurality of partially- or fully-animated images for storing locally or remotely, or uploading to a website. Further, the image processing system has the capability of transmitting and receiving information related to the partially- or fully-animated images in a video instant messaging or conferencing session.

### CROSS REFERENCE TO A RELATED APPLICATION

This application claims the benefit of the filing date of Provisional Application Ser. No. 60/976,377, filed on Sep. 28, 2007, and entitled “System and Method for Tracking Multiple Face Images for Generating Corresponding Moving Altered Images,” which is incorporated herein by reference.

### FIELD AND BACKGROUND OF THE INVENTION

This invention relates generally to image processing, and in particular, to a system and method for tracking the movement, orientation, and expression of multiple faces and generating corresponding altered images that track the movement, orientation, and expression of the multiple faces.

### BRIEF DESCRIPTION OF THE DRAWINGS

FIG. 1 illustrates a block diagram of an exemplary image processing system in accordance with an embodiment of the invention;

FIG. 2 illustrates a block diagram of another exemplary image processing system in accordance with another embodiment of the invention;

FIG. 3 illustrates a flow diagram of an exemplary method of creating multiple face objects in accordance with another embodiment of the invention; and

FIG. 4 illustrates a flow diagram of an exemplary method of tracking the movement of multiple faces and generating corresponding moving altered images.

### DETAILED DESCRIPTION OF THE EXEMPLARY EMBODIMENTS

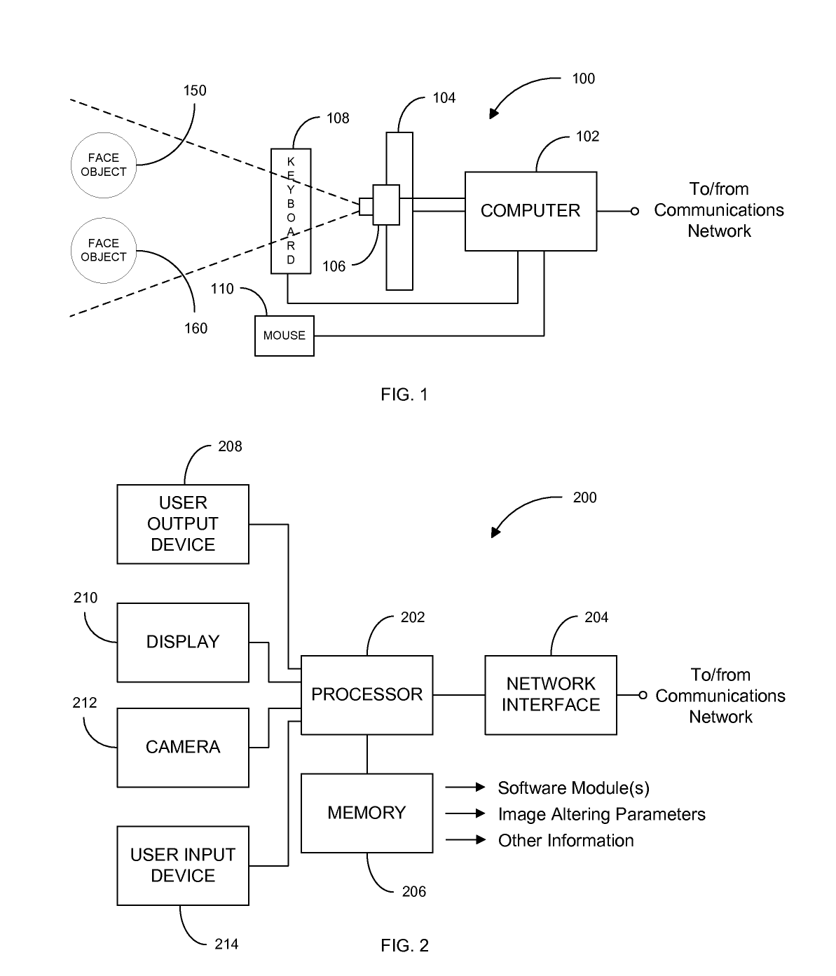

FIG. 1 illustrates a block diagram of an exemplary image processing system 100 in accordance with an embodiment of the invention. The image processing system 100 is particularly suited for tracking the movement, orientation, and expression of multiple faces and generating corresponding altered images that track the movement, orientation, and expression of the multiple faces. The image processing system 100 is a computer-based system that operates under the control of one or more software modules to implement this functionality and others, as discussed in more detail below.

In particular, the system comprises a computer 102, a display 104 coupled to the computer 102, a still-picture and/or video camera 106 coupled to the computer 102, a keyboard 108 coupled to the computer 102, and a mouse 110 coupled to the computer 102. The camera 106 generates a video image of multiple faces that appear in its view. In this example, the camera 106 is generating a video image of two faces 150 and 160. The camera 106 provides the video image to the computer 102 for generating corresponding altered images on the display 104 that track the movement, orientation, and expression of the captured face images.

The keyboard 108 and mouse 110 allows a user to interact with software running of the computer 102 to control the video image capture of the multiple faces 150 and 160 and generate corresponding altered images on the display 104. For instance, the keyboard 108 and mouse 110 allow a user to design the altered images corresponding to the multiple faces 150 and 160. For example, a user may design an altered image corresponding to the face 150 that includes at least partial of the captured face image and additional graphics to be overlaid with the at least partial captured face image. As an example, a user may design an altered image that adds a graphical hat or eyeglasses to the captured face image. The user may design a full graphical altered image, typically termed in the art as an “avatar”, corresponding to the face 160.

Once the user has created the corresponding altered images for the faces 150 and 160, the user may interact with the software running on the computer 102 to track the movement, orientation, and expression of the faces and to generate the corresponding altered images on the display 104 that track the movement, orientation, and expression of the corresponding altered images. For example, when the faces 150 and 160 move laterally, the corresponding altered images on the display 104 also move laterally with the respective faces 150 and 160 in substantially “real time.” Similarly, when the faces 150 and 160 change orientation by, for example, yawing or pitching, the corresponding altered images on the display 104 also change their orientation with the respective faces 150 and 160 in substantially “real time.” Additionally, when the faces 150 and 160 change facial expression, such as closing of one or both eyes, opening of the mouth, or raising of one or both eyebrows, the corresponding altered images on the display 104 also change facial expression with the respective faces 150 and 160 in substantially “real time.”

The user may interact with the software running on the computer 102 to create a video clip or file of the altered images that tracks the movement, orientation, and expression of the captured face images 150 and 160. In this manner, two or more users can create an animated or partially animated video clip or file. The user may interact with the software running on the computer 102 to upload the video clip or file to a website for posting, allowing the public to view the video clip or file. This makes creating an animated or partial-animated video clip or file relatively easy.

Additionally, the user may interact with the software running on the computer 102 to perform video instant messaging or video conferencing with the altered images being communicated instead of the actual images of the faces 150 and 160. This enhances the video instant messaging and conferencing experience.

FIG. 2 illustrates a block diagram of another exemplary image processing system 200 in accordance with another embodiment of the invention. This may be a more detailed embodiment of the image processing system 100 previously described. Similar to the previous embodiment, the image processing system 200 is particularly suited for tracking the movement, orientation, and expression of multiple faces and generating corresponding altered images that track the movement, orientation, and expression of the multiple faces. The image processing system 200 also allows a user to design the altered images, to generate a video clip or file of the altered images, and to transmit the altered images to another device on a shared network.

In particular, the image processing system 200 comprises a processor 202, a network interface 204 coupled to the processor 202, a memory 206 coupled to the processor 202, a display 210 coupled to the processor 202, a camera 212 coupled to the processor 202, a user output device 208 coupled to the processor 202, and a user input device 214 coupled to the processor 202. The processor 202, under the control of one or more software modules, performs the various operations described herein. The network interface 204 allows the processor 202 to send communications to and/or receive communications from other network devices. The memory 206 stores one or more software modules that control the processor 202 to perform its various operations. The memory 206 may also store image altering parameters and other information.

The display 210 generates images, such as the altered images that track the movement, orientation, and expression of the multiple faces. The display 210 may also display other information, such as image altering tools, controls for creating a video clip or file, controls for transmitting the altered images to a device via a network, and images received from other network devices pursuant to a video instant messaging or video conferencing experience. The camera 212 captures the images of multiple faces for the purpose of creating and displaying the corresponding altered images. The user output device 208 may include other devices for the user to receive information from the processor, such as speakers, etc. The user input device 214 may include devices that allow a user to send information to the processor 202, such as a keyboard, mouse, track ball, microphone, etc. The following processes are described with reference to the image processing system 200.

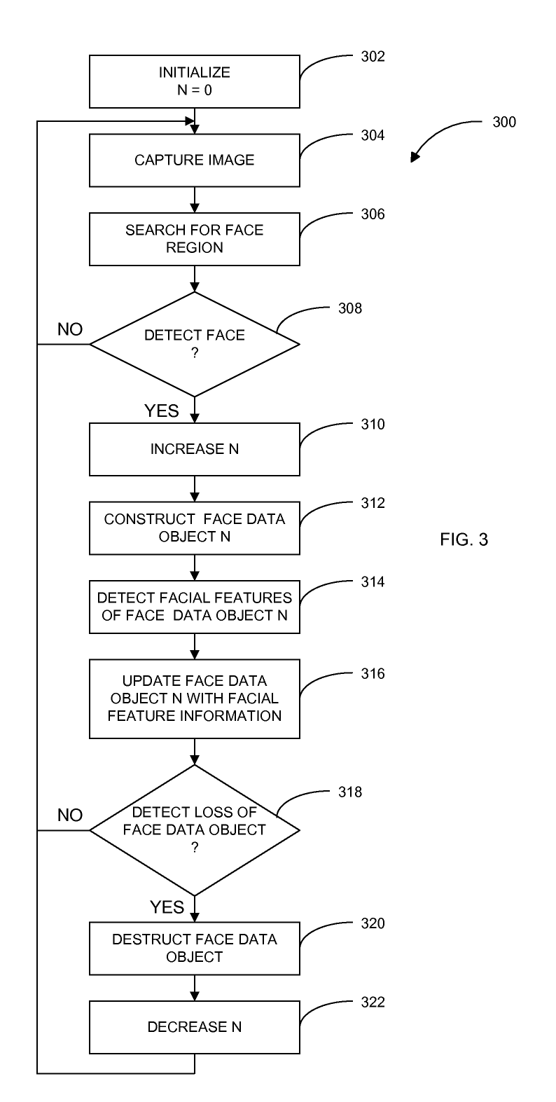

FIG. 3 illustrates a flow diagram of an exemplary method 300 of creating multiple face objects in accordance with another embodiment of the invention. The processor 202 first initializes the number N of created face object to zero (0) (block 302). The processor 202 then controls the camera 212 to capture an image that includes multiple faces (block 304). The processor 202 then searches the received image to detect a face region (block 306). The processor 202 then determines whether a face was detected (block 308). If the processor 202 does not detect a face, the processor 202 continues to receive images from the camera 212 as per block 304 to continue to search for a face image per block 306.

If the processor 202 in block 308 detects a face image, the processor then increases N, the number of created face data objects (block 310). The processor 202 then constructs the face data object corresponding to the detected face image (block 312). The processor 202 then analyzes the face image to detect facial features of the face, such as the location of its eyes, mouth, nose, eyebrows, and others (block 314). The processor 202 then updates the created face data object to include the facial feature information obtained in block 314 (block 316).

The processor 202 then may detect the loss of a face image corresponding to a created face object (block 318). This may be the case where the person in front of the camera 212 moves away from the camera's view point, or orients his/her face such that the camera 212 is unable to capture the face image. If the processor 202 does not detect a loss in a face image per block 318, the processor 202 then continues to receive the image from the camera 212 as per block 304 in order to search for more face images as per block 306. If the processor 202 detects a loss of a face image corresponding to a created face data object, the processor 202 then destructs the corresponding face data object (block 320). This may not be done immediately but after a predetermined time period. This is because it may not be desirable to destruct a created face data object for a momentary loss of the corresponding face image. After it destructs the face data object, the processor 202 decreases N, the number of active face data object (block 322). The processor 202 may then return to block 304 to receive more images from the camera 212 per block 304 in order to detect more face images per block 306.

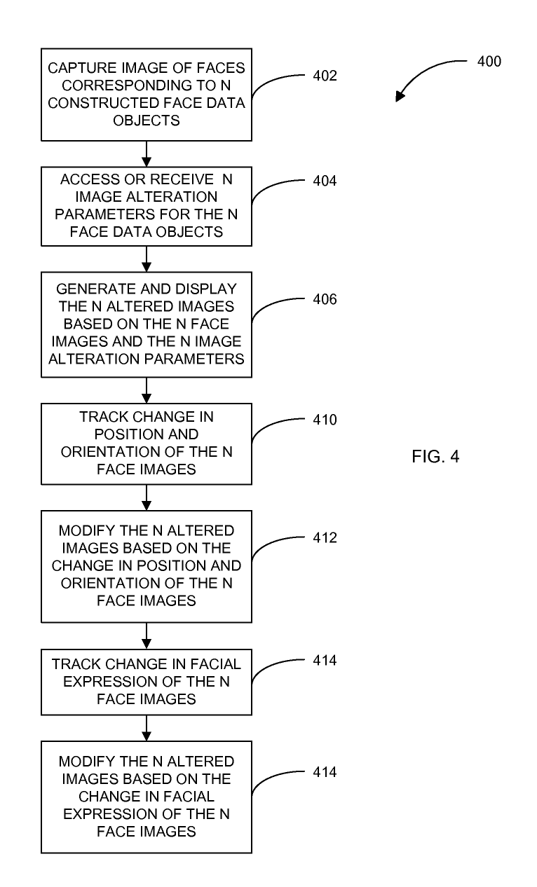

FIG. 4 illustrates a flow diagram of an exemplary method 400 of tracking the movement, orientation, and expression of multiple faces and generating corresponding altered images that track the movement, orientation, and expression of the multiple faces. According to the method 400, the processor 202 receives face images from the camera 212 corresponding to the N constructed face data objects (block 402). The processor 202 then accesses or receives N image alteration parameters corresponding to the N face data objects (block 404). The processor 202 then generates on the display 210 the N altered images based on the N face images and the corresponding N image alteration parameters stored respectively in the N face data objects (block 406).

The processor 202 tracks changes in position and orientation of the N face images received from the camera 212 (block 410). The processor 202 then modifies the N altered images based on the change in position and orientation of the N face images, respectively (block 412). The processor 202 also tracks changes in the facial expression of the N face images received from the camera 212 (block 414). The processor 202 then modifies the N altered images based on the change in facial expression of the N face images (block 414).

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of processing images, comprising:
receiving a first face image;
receiving a second face image; and
generating first and second altered images simultaneously on a display corresponding to the first and second face images.

2. The method of claim 1, further comprising:
detecting a movement of the first face image;
generating a corresponding movement of the first altered image on the display.

3. The method of claim 2, further comprising:
detecting a movement of the second face image;
generating a corresponding movement of the second altered image on the display.

4. The method of claim 1, further comprising:
detecting a change in orientation of the first face image;
generating a corresponding change in orientation of the first altered image on the display.

5. The method of claim 4, further comprising:
detecting a change in orientation of the second face image;
generating a corresponding change in orientation of the second altered image on the display.

6. The method of claim 1, further comprising:
detecting a change in a facial expression of the first face image;
generating a corresponding change in a facial expression of the first altered image on the display.

7. The method of claim 6, further comprising:
detecting a change in a facial expression of the second face image;
generating a corresponding change in a facial expression of the second altered image on the display.

8. The method of claim 1, wherein the first altered image comprises a fully-animated image.

9. The method of claim 1, wherein the first altered image comprises a partially-animated image.

10. The method of claim 9, wherein the partially-animated image comprises at least a portion of the first face image.

11. The method of claim 1, further comprising recording the first and second altered images to generate a video clip or file.

12. The method of claim 1, further comprising transmitting information related to the first and second altered images to a device via a network.

13. The method of claim 1, further comprising:
receiving information related to a third face image from a device via a network; and
generating a third altered image on the display corresponding to the third face image.

14. The method of claim 13, wherein the third altered image is displayed simultaneously with the first and second altered images on the display.

15. The method of claim 13, wherein the information related to the third face image includes a movement of the third face image; and further comprising generating a corresponding movement of the third altered image on the display.

16. The method of claim 13, wherein the information related to the third face image includes a change in orientation of the third face image; and further comprising generating a corresponding change in orientation of the third altered image on the display.

17. The method of claim 13, wherein the information related to the third face image includes a change in facial expression of the third face image; and further comprising generating a corresponding change in facial expression of the third altered image on the display.

18. The method of claim 13, further comprising receiving information related to an animation of the third altered image from the device via the network, wherein generating the third altered image on the display is based on the animation information.

19. An image processing system, comprising:
a display;
an image capturing device adapted to capture first and second face images; and
a processor adapted to generate first and second altered images simultaneously shown on the display that corresponds to the first and second face images.

20. The image processing system of claim 19, wherein the processor is further adapted to:
detect respective movements of the first and second face images; and
generate corresponding movements of the first and second altered images on the display.

21. The image processing system of claim 19, wherein the processor is further adapted to:
detect change in orientations of the first and second face images; and
generate corresponding change in orientations of the first and second altered images on the display.

22. The image processing system of claim 19, wherein the processor is further adapted to:
detect change in facial expressions of the first and second face images; and
generate corresponding changes in facial expressions of the first and second altered images on the display.

23. The image processing system of claim 19, wherein the first altered image comprises a fully-animated image.

24. The image processing system of claim 23, wherein the second altered image comprises a partially-animated image.

25. The image processing system of claim 19, wherein the first altered image comprises a partially-animated image.

26. The image processing system of claim 19, wherein the processor is further adapted generate a video clip or file comprising a recording of the first and second altered images.

27. The image processing system of claim 19, further comprising a network interface, wherein the processor is adapted to transmit information related to a movement, change in orientation, and change in facial expression of the first and second altered images to a device via the network interface.

28. The image processing system of claim 27, wherein the processor is further adapted to:
receive information related to a third face image from the device via the network interface; and
generate a third altered image on the display corresponding to the third face image.

29. An image processing system, comprising:
a display;
an image capturing device adapted to capture first and second face images; and
a processor adapted to generate first and second partially- or fully-animated images simultaneously shown on the display that corresponds to the first and second face images.

30. The image processing system of claim 29, wherein the processor is further adapted to:
detect respective movements, changes in orientations, and changes in facial expressions of the first and second face images; and
generate corresponding movements, changes in orientations, and changes in facial expressions of the first and second partially- or fully-animated images on the display in substantially real time with the respective movements, changes in orientations, and changes in facial expressions of the first and second face images.

31. The image processing system of claim 30, wherein the processor is further adapted generate a video clip or file comprising a recording of the first and second partially- or fully-animated images moving, changing orientations, and changing facial expressions.

32. The image processing system of claim 30, further comprising a network interface, wherein the processor is adapted to transmit information related to the movement, changes in orientations, and changes in facial expressions of the first and second partially- or fully-animated images to a device via the network interface.

33. A computer readable medium including one or more software modules adapted to:
receive a first face image;
receive a second face image; and
generate first and second partially- or fully animated images simultaneously on a display corresponding to the first and second face images.
